(19) United States
(12) Patent Application Publication
(10) Pub. No.: US 2004/0146660 A1
(43) Pub. Date: Jul. 29, 2004

(54) Surface treatment

(76) Inventors: Andrew James Goodwin, Cork (IE); Luke Ward, Durham (GB); Patrick Merlin, Neufvilles (BE); Jas Pal Singh Badyal, Wolsingham (GB)

Correspondence Address: McKellar Stevens, Poseyville Professional Complex, 784 South Poseyville Road, Midland, MI, 48640, US

(21) Appl. No.: 10/479,776

(22) PCT Filed: Jun. 5, 2002
(86) PCT No.: PCT/GB02/02543

(30) Foreign Application Priority Data
Jun. 6, 2001 (GB) 0113751.2

(51) Int. Cl. H05H 1/24

(52) U.S. Cl. 427/535; 427/569

(57) ABSTRACT

A method of coating a surface of a low surface energy substrate by exposing the substrate to a silicon containing compound in liquid or gaseous form selected from a chlorine terminated polydimethylsiloxane, direct process residue, ZₓSiR⁵₄₋ₓ, SiₙY₂ₙ₊₂ or a mixture thereof, where each Z is a chloro or alkoxy group and each R⁵ is an alkyl group or substituted alkyl group, x is 1 to 4, n is from 2 to 10 and each Y may be selected from a chloro, fluoro, alkoxy or alkyl group but at least two Y groups must be chloro, or alkoxy groups or a mixture thereof and forming a grafted coating layer on the substrate surface and subsequently post-treating the grafted coating layer by oxidation or, reduction, which is preferably utilising a plasma or corona treatment, in particular atmospheric pressure glow discharge or dielectric barrier discharge.

The present invention relates to a method of coating a low surface energy substrate.

The use of plasma treatment techniques to modify substrate surfaces is well known; in general, a substrate is treated by placing it within a reactor vessel and subjecting it to a plasma discharge. The effect on the surface depends largely upon the gaseous material present within the reactor during the plasma discharge. For example, plasma treatment may activate species on the substrate surface which augment adhesion of the substrate with other materials, or deposition of materials onto the substrate surface.

Tailored surface properties are required in a broad range of applications including biocompatibility, oil and fuel resistance, adhesion, optical and barrier properties. Polymeric materials often have ideal bulk, mechanical, processing and cost qualities, but do not always have the required surface properties. Reactive silanes have been widely used to modify highly hydroxylated mineral and metal surfaces. However, because of their low surface energy and chemical inertness, polymeric surfaces are significantly less likely to be susceptible to wetting adhesion or reactive grafting. There are many examples of oxidative treatments for activating plastic surfaces prior to printing, laminating, adhering or grafting.

Corona discharge treatment is one of the most commonly used methods for activating a plastic surface prior to forming an adhesive bond. A corona discharge is typically produced by applying a high voltage (approximately 5 to 10 kV) relatively high frequency (e.g. 10 kHz) signal to electrodes in air at atmospheric pressure. However, whilst Corona discharge treatment does have the advantage of operating at atmospheric pressure, there are several significant limitations to the usefulness of corona discharge treatments. In particular corona discharges are produced from point sources, and as such produce localised energetic discharges, which are commonly known as streamers. The production of localised energetic discharges often result in a non-uniform treatment of the substrate.

EP 0978324 describes the use of oxidative low pressure glow discharge plasma to activate plastic surfaces prior to grafting gaseous organosilicon reagents on to the plastic surfaces to enhance biocompatibility. The most preferred organosilicon reagents are in particular organosilanes of the formula:

R¹ₙSiR²ₘ (I)

wherein each group R¹ is independently selected from the group consisting of hydrogen or optionally substituted alkenyl; each group R² is independently selected from an optionally substituted alkyl group of 1 to 20 carbon atoms; or a group (OR³) or (OSiR³₃), where each R³ is independently an optionally substituted alkyl group of 1 to 20 carbon atoms; n is an integer of 1 to 3; m is an integer of 1 to 3 and n+m is 4; and organosiloxanes of the structure (II)

R¹ₐR²₍₃₋ₐ₎Si(OSiR⁴₂)ₓOSiR¹_{b}R²_{(3-b)} (II)

wherein each R¹ and R² are as defined above, each group R⁴ is independently selected from the group consisting of hydrogen, optionally substituted alkenyl groups; optionally substituted alkyl groups of 1 to 20 carbon atoms and aryl groups, with the proviso that at least one R¹ or R⁴ group per molecule is an unsubstituted alkenyl group or a hydrogen; a is 0, 1, 2, or 3 and b is 0, 1, 2, or 3, x is 0 or a positive integer. However, such plasma surface treatments require the substrate to be under conditions of reduced pressure, and hence require a vacuum chamber. Typical coating-forming gas pressures are in the range 5 to 25 Nm⁻² (1 atmosphere=1.01×10⁵ Nm⁻²). As a result of the requirement for reduced pressure, this type of surface treatment is expensive, is limited to batch treatments, and the coating-forming materials must be gaseous in order to maintain conditions of reduced pressure.

In U.S. Pat. No. 5,372,851 plasma activated surfaces are treated with multifunctional Si—X materials to produce a hydrophilic siloxane network prior to grafting with a functional silane.

Disilane has been used as a reactant in prior art applications for example in the preparation of tungsten silicide films as described in EP 0256337, nitride films as described in EP0935284, silicon dioxide coatings as described in U.S. Pat. No. 5,098,865 and silicon nitride coatings in the semi-conductor chip market.

Halosilanes and organohalosilanes, in particular methylchlorosilanes, are the building-blocks from which silicone polymers are produced. Halosilanes and organohalosilanes are commercially produced by what is commonly called “the direct process”, in which silicon metal is reacted with an organic halide or hydrogen chloride, optionally in the presence of a catalyst. For example, in the commercial production of methylchlorosilanes by the direct process, silicon metal is reacted with methyl chloride (CH₃Cl) in the presence of a catalyst. The direct process is well known in the art, and is well described in patent literature, see for example UK Patent Numbers 375667, 375668, 375669, 375673 and 375674. For commercial production of methylchlorosilanes, the reaction takes place in a fluid bed reactor in which finely ground silicon metal powder is fluidised by passing methyl chloride gas there through at a temperature of between 200° C. and 500° C. A by-product of the direct process is direct process residue (DPR). DPR comprises a mixture of the higher boiling point halosilanes produced by the direct process. DPR is a chemically active, hazardous material. The activity of DPR must be reduced prior to transportation and/or disposal. Thus, once separated from the other reaction products, DPR is neutralised, for example, with lime solution, to reduce its activity, and may be dewatered to form a gel-solids mixture, generally known as “DPR gel”.

The inventors have now developed a method of coating surfaces of low surface energy substrates.

The present invention provides a method of coating a surface of a low surface energy substrate by the following steps:

(i) exposing the substrate to a silicon containing compound in liquid or gaseous form said silicon containing composition being selected from one or more of a chlorine terminated polydimethylsiloxane, direct process residue, ZₓSiR⁵₄₋ₓ, SiₙY₂ₙ₊₂ or a mixture thereof, where each Z is chloro or an alkoxy group and each R⁵ is an alkyl group or a substituted alkyl group, x is 1,2,3 or 4, n is from 2 to 10 and each Y may be selected from a chloro, fluoro, alkoxy or alkyl group but at least two Y groups must be chloro or alkoxy groups or a mixture thereof to form a grafted coating layer on the substrate surface; and

(ii) post-treating the grafted coating layer prepared in step (i) by oxidation or, reduction.

For the sake of clarification it is to be understood that for the purpose of this patent application a low surface energy substrate is a substrate which has a maximum surface energy of 50 mJ/m².

Most preferably the method is undertaken at room temperature and pressure.

The silicon containing compound in liquid or gaseous form used in accordance with the method of the present invention is selected from a chlorine terminated polydimethylsiloxane, a direct process residue, silanes of the formula ZₓSiR₄₋ₓ and SiₙY₂ₙ₊₂ or a mixture thereof.

When the silicon containing compound is a chlorine terminated polydimethylsiloxane the degree of polymerisation thereof is preferably between 5 and 20 and most preferably between 5 and 10 and each terminal silicon in the chain may have 1, 2 or 3 Si—Cl bonds.

When the silicon-containing compound is a silane of the formula ZₓSi R⁵₄₋ₓ, it is preferred that each R⁵ group is the same or different and is an alkyl group or a substituted alkyl group. In the case when R⁵ is an alkyl group it may comprise any linear or branched alkyl group having from 1 to 10 carbon atoms such as a methyl, ethyl, 2-methyl hexyl, or isopropyl group. When R⁵ is a substituted alkyl group, said group preferably comprises any linear or branched alkyl group having from 1 to 10 carbon atoms and at least one substituted group selected from, for example fluoro, chloro, epoxy, amine, acrylate, methacrylate, mercapto. Most preferably the substituted group is a fluoro group. Each Z may be the same or different and is preferably an alkoxy or chloro group, most preferably a chloro group. Preferably x is 3.

When the silicon containing compound is a silane of the formula SiₙY₂ₙ₊₂, each Y is the same or different and at least two but not more than 2n+1 Y groups per SiₙY₂ₙ₊₂ molecule are chloro or alkoxy groups. Preferably n is between 2 and 5, most preferably n is 2 or 3. When Y is an alkyl group preferably each alkyl group is a methyl, ethyl or isopropyl group, most preferably a methyl group. When Y is an alkoxy group the alkyl group thereof is preferably a methyl, ethyl or isopropyl group, most preferably a methyl group.

Most preferably the silicon containing compound is direct process residue.

In the method of the present invention the substrate is generally exposed to the silicon containing compound in a sealed container. In the case of a SiₙY₂ₙ₊₂ molecule or direct residue in particular, it is believed that the coating is grafted onto the low surface energy substrate without the need for prior activation of the substrate, i.e. it forms a grafted coating layer by covalently bonding with groups on the surface of the substrate, an action only previously observed in the prior art when the substrate was exposed to activation by, for example, plasma or corona treatment prior to the grafting process. Most preferably the method is undertaken at room temperature and pressure.

The grafted coating layer provided in step (i) of the method of the present invention is subsequently oxidised or reduced. Preferably said oxidation or reduction is achieved using a plasma or corona treatment, most preferably dielectric barrier discharge (DBD) or atmospheric pressure glow discharge (APGD).

Upon oxidation, the grafted coating layer will subsequently comprise groups of the formula Si—Oₘ and may then be further treated, for example, subsequent to oxidation the treated substrate may be subjected to any one of the following:

(i) further chemical grafting processes to produce an additional mono-layer or multilayer systems.

(ii) Coated with a plasma polymerised coating

(iii) May be coated with a liquid by means of a traditional coating process, or

(iv) May be laminated to another similarly prepared substrate.

In the case of further chemical grafting, any suitable grafting agent may be utilised providing it reacts with the available Si—O_{m.} groups. This chemical grafting process may provide the opportunity to apply one or more additional layers of the silicon containing material defined above onto the substrate to effectively build up the thickness of the silicon containing coating on the substrate surface.

Additional layers of silicon containing materials may be applied onto the oxidised, grafted coating layer of silicon containing compound by repeating the method described above, i.e. by applying a further grafted coating layer onto the oxidised coating layer, said further grafted coating layer comprising an oxidisable silicon containing compound which may again be selected from a chlorine terminated polydimethylsiloxane, direct process residue, ZₓSi R⁵₄₋ₓ, SiₙY₂ₙ₊₂ or a mixture thereof. The resulting further grafted coating layer may then, if required, be oxidised by, for example, applying a plasma or corona treatment on the further grafted coating layer. The above may be repeated until a predetermined number of further grafted coating layers have been applied onto the substrate.

Alternatively once the silicon containing compound in accordance with the present invention has been applied to form the grafted coating on the substrate surface and has then been oxidised any suitable coating material which is reactable with the resulting Si—Oₘ groups may be utilised to form the next additional coating layer, these may comprise for example suitable silicon containing materials such as those described in EP 0978324 and discussed previously herein. Where necessary each additional layer may be oxidised or reduced in order to achieve the required surface characteristics.

A top coat may be applied to the outermost grafted coating layer. Such a top coat may comprise any suitable composition but preferably comprises a silicon containing compound which may be but is not necessarily oxidisable.

Reduction of the grafted coating layer obtained by the process according to the present invention may be achieved by plasma treating the substrate in a hydrogen or nitrogen atmosphere which is preferably free from oxygen and water vapour. Alternatively reduction may be achieved by applying the grafted coating layer in accordance with the present invention in a nitrogen or hydrogen rich atmosphere. The resulting oxygen free layers will typically be rich in silicon and/or silicon carbide groups.

Preferably plasma or corona treatment as described herein may be applied by any conventional means. Many different plasma treatment processes are known, and for example, in the case of oxidation being required any oxidative treatment process which can convert the organosilicon-containing additive on the substrate surface to SiOₘ is suitable for use in the method of the present invention. Suitable oxidative treatment processes include, for example, O₂, UV, VUV, IR, ozone, and plasma (including d.c., low frequency, high frequency, microwave, ECR, corona, dielectric barrier and atmospheric glow discharge) treatment processes. The gas for use in the plasma treatment process may be, for example, an oxygen-containing gas, e.g. O₂H₂O, NO₂, and air, or an inert gas; however, when the latter is used in plasma treatment processes etching of the substrate surface may also occur and hence oxygen-containing gasses, in particular O₂ and air, are preferred. Gas pressure may be atmospheric pressure or lower, for example, from 10 Nm⁻² to 1000 Nm⁻². Preferred methods of application are by DBD and particularly APGD.

In the case of oxidation, the duration of the plasma or corona treatment to effect an oxidised surface will depend upon the particular substrate in question and the desired degree of conversion of organosilicon compound on the surface of the substrate to SiOₘ, and this will typically be the order of seconds.

Plasma treatment of the substrate surface may be performed with substrate heating and/or pulsing of the plasma discharge. The substrate may be heated to a temperature up to and below its melting point. Substrate heating and plasma treatment may be cyclic, i.e. the substrate is plasma treated with no heating, followed by heating with no plasma treatment, etc., or may be simultaneous, i.e. substrate heating and plasma treatment occur together. A particularly preferred plasma treatment process involves pulsing the plasma discharge with constant heating of the substrate. The plasma discharge is pulsed to have a particular “on” time and “off” time. The on-time is typically from 10 to 10000 μs, preferably 100 to 1000 μs, and the off-time typically from 1000 to 10000 μs, preferably from 1000 to 2000 μs.

Most preferably the atmospheric pressure plasma glow discharge will employ a helium diluent and a high frequency (e.g.>1 kHz) power supply to generate a homogeneous atmospheric pressure glow discharge via a Penning ionisation mechanism, (see for example, Kanazawa et al, J. Phys. D: Appl. Phys. 1988, 21, 838, Okazaki et al, Proc. Jpn. Symp. Plasma Chem. 1989, 2, 95, Kanazawa et al, Nuclear Instruments and Methods in Physical Research 1989, B37/38, 842, and Yokoyama et al., J. Phys. D: Appl. Phys. 1990, 23, 374).

Where deemed necessary the low surface energy substrate may be activated by an atmospheric pressure plasma or a corona discharge treatment, for example, atmospheric pressure glow discharge or direct barrier discharge prior to exposure to the silicon containing compound in order to enhance the activity of the low surface energy substrate surface. Preferably prior to exposing the low surface energy substrate to a chlorine terminated polydimethylsiloxane, or a silane of the formula, ZₓSiR⁵₄₋ₓ, separately or in combination with each other, the low energy substrate is subjected to a plasma pre-treatment. But prior to exposing the low surface energy substrate to an oxidisable silicon containing compound comprising a direct process residue, or a compound of the formula SiₙY₂ₙ₊₂ the substrate may be subjected to a plasma pre-treatment but such treatment is optional.

The low surface energy substrate to be coated may comprise any appropriate material, for example thermoplastics such as polyolefins e.g. polyethylene, and polypropylene, polycarbonates, polyurethanes, polyvinylchloride, polyesters (for example polyalkylene terephthalates, particularly polyethylene terephthalate), polymethacrylates (for example polymethylmethacrylate and polymers of hydroxyethylmethacrylate), polyepoxides, polysulphones, polyphenylenes, polyetherketones, polyimides, polyamides, polystyrenes, phenolic, epoxy and melamine-formaldehyde resins, and blends and copolymers thereof. Preferred organic polymeric materials are polyolefins, in particular polyethylene and polypropylene.

Alternatively the substrate may be in the form of synthetic and/or, natural fibres, woven or non-woven fibres, powder.

In a further embodiment the substrate may be of the type described in the applicant's co-pending application WO 01/40359, which was published after the priority date of the present invention, wherein the substrate comprises a blend of an organic polymeric material and an organosilicon-containing additive which is substantially non-miscible with the organic polymeric material. The organic polymeric material may be any of those listed above, the organosilicon-containing additive are preferably linear organopolysiloxanes. In the case of such substrates the organosilicon-containing additive migrates to the surface of the mixture and as such is available for reaction or where deemed necessary plasma or corona treatment. It is to be understood that the term “substantially non-miscible” means that the organosilicon-containing additive and the organic material have sufficiently different interaction parameters so as to be non-miscible in equilibrium conditions. This will typically, but not exclusively, be the case when the Solubility Parameters of the organosilicon-containing additive and the organic material differ by more than 0.5 MPa^{1/2.}

However, if atmospheric pressure glow discharge is the preferred means of plasma treatment, the size of the substrate is limited by the dimensions of the area within which the atmospheric pressure plasma discharge is generated, i.e. the distance between the electrodes of the means for generating the plasma. For typical plasma generating apparatus, the plasma is generated within a gap of from 5 to 50 mm, for example 10 to 25 mm. Thus, the present invention has particular utility for coating films, fibres and powders. One means of enhancing the size of the substrate is by having the substrate attached to two reels, such that at the start of one cycle the substantial majority of the substrate is wound around a first reel and during the cycle is passed through the area of the electrodes and is subsequently wound onto the second reel. In this case the cycle may finish either once the single run is complete or if desired, for example, after the reverse run so that the cycle is always completed with the substrate wound around the first reel. If this type of method is used it is essential to ensure that each cycle is of the same duration.

Substrates coated by the method of the present invention may have various utilities. For example, coatings may increase hydrophobicity, oleophobicity, fuel and soil resistance, water resistance and/or the release properties of the substrate; and may enhance the softness of fabrics to touch. The utilisation of multiple layered coated substrates appear to enhance the advantages observed.

The present invention will now be illustrated in detail with reference to the following examples.

### EXAMPLE 1

### Grafting of Direct Process Residue to Polyethylene in Dry Nitrogen

Polyethylene film substrates were prepared by ultrasonic cleaning for 30 seconds in a 1:1 mixture of propan-2-ol and cyclohexane. One polyethylene sample was then activated using DBD apparatus in air (voltage up to 11 kV, 328 Hz, 2 mm inter-electrode gap, 10 seconds treatment). A second polyethylene sample was exposed to the reagent without prior activation.

The polyethylene samples were then placed on raised platform in a sealed 60 cm³ vessel within an atmosphere of dry nitrogen that contained 0.02 ml of direct process residue (DPR). After exposure to the DPR vapour for 1 hour the samples were removed and washed for one minute in dry toluene under a dry nitrogen atmosphere. The films produced from DPR were then analysed using contact angles of deionised water and X-ray photoelectron spectroscopy (XPS) and the results are shown in Table 3.

TABLE 1

| Exposure | | | | | | Contact |
|---|---|---|---|---|---|---|
| Environment | Substrate | % C | % O | % Si | % Cl | Angle |
| Dry nitrogen, | Polyethylene | 60.1 | 18.6 | 19.1 | 2.2 | 104.0° |
| washed in | | | | | | |
| dry nitrogen | | | | | | |
| Dry nitrogen, | Polyethylene + | 46.4 | 25.1 | 24.6 | 4.0 | 90.6° |
| washed in | DBD | | | | | |
| dry nitrogen | | | | | | |

It will be clearly seen that the application of DPR vapour resulted in the formation of effective coatings on polyethylene surfaces both with and without prior activation. High levels of Cl are retained in the coating due to low exposure to atmospheric moisture.

### EXAMPLE 2

### Grafting of Direct Process Residue to Polyethylene in Dry Nitrogen/Air

Polyethylene film substrates were prepared by ultrasonic cleaning for 30 seconds in a 1:1 mixture of propan-2-ol and cyclohexane. One polyethylene sample was then activated using DBD apparatus in air (voltage up to 11 kV, 328 Hz, 2 mm inter-electrode gap, 10 seconds treatment). A second polyethylene sample was exposed to the grafting reagent without prior activation.

The polyethylene samples were then placed on raised platform in a sealed 60 cm³ vessel within an atmosphere of dry nitrogen that contained 0.02 ml of DPR. After exposure to the DPR vapour for 1 hour the samples were removed and washed for one minute in dry toluene in ambient atmosphere. The films produced from DPR were then analysed using contact angles of deionised water and X-ray photoelectron spectroscopy (XPS) and the results are shown in Table 2.

TABLE 2

| Exposure | | | | | | Contact |
|---|---|---|---|---|---|---|
| Environment | Substrate | % C | % O | % Si | % Cl | Angle |
| Dry nitrogen, | Polyethylene | 49.2 | 24.9 | 25.5 | 0.4 | 91.4° |
| washed in air | | | | | | |
| Dry nitrogen, | Polyethylene + | 46.0 | 25.9 | 27.2 | 0.9 | 84.8° |
| washed in air | DBD | | | | | |

DPR effectively grafts both to an activated and non activated polyethylene surface to produce a siloxane coating. Low levels of Cl indicate hydrolysis of the residual Si—Cl bonds within the coating, based on the following reaction at Si—Cl bonds.

(Si—Cl+H₂O→Si—OH+HCl)

### EXAMPLE 3

### Grafting of Direct Process Residue to Polyethylene in Air

Polyethylene film substrates were prepared by ultrasonic cleaning for 30 seconds in a 1:1 mixture of propan-2-ol and cyclohexane. One polyethylene sample was then activated using DBD apparatus in air (up to 11 kV, 328 Hz, 2 mm inter-electrode gap, 10 seconds treatment). A second polyethylene sample was exposed to the grafting reagent without prior activation.

The polyethylene samples were then placed on raised platform in a sealed 60 cm³ vessel within an ambient atmosphere that contained 0.02 ml of DPR. After exposure to the DPR vapour for 1 hour the samples were removed and washed for one minute in dry toluene in ambient atmosphere. The films produced from DPR were then analysed using contact angles of deionised water and X-ray photoelectron spectroscopy (XPS) and the results are shown in Table 3.

TABLE 3

| Exposure | | | | | | Contact |
|---|---|---|---|---|---|---|
| Environment | Substrate | % C | % O | % Si | % Cl | Angle |
| Air, washed in air | Polyethylene | 45.4 | 26.9 | 27.7 | 0 | 90.6° |
| Air, washed in air | Polyethylene + | 40.1 | 28.9 | 30.5 | 0.5 | 92.4° |
| | DBD | | | | | |

DPR effectively grafts both to an activated and non activated polyethylene surface to produce a siloxane coating. Low levels of Cl are retained when grafting and washing is carried out in ambient conditions.

DPR effectively grafts both to an activated and non-activated polyethylene substrate in ambient conditions to produce a siloxane coating. Low levels of Cl indicate hydrolysis of the residual Si—Cl bonds within the coating. In this case the Cl results are particularly low due to exposure to atmospheric moisture during both the grafting and washing steps.

### EXAMPLE 4

### DBD Oxidation of Grafted Layers Produced in Examples 1 and 3

Coatings derived from DPR described in the Example 1 and Example 3 above were further oxidised by treatment with dielectric barrier discharge apparatus in air (up to 11 kV, 328 Hz, 2 mm inter-electrode gap, 60 seconds treatment). The oxidised samples were then analysed using XPS and the results are shown in Table 4.

TABLE 4

| Exposure | | | | | | |
|---|---|---|---|---|---|---|
| Environment | Sample | % C | % O | % Si | % Cl | % SiOx |
| Air, washed | DPR Film + DBD | 21.3 | 53.4 | 25.3 | 0 | 70.8 |
| in air | | | | | | |
| Dry nitrogen, | DPR Film + DBD | 30.7 | 48.9 | 20.5 | 0 | 57.7 |
| washed in | | | | | | |
| dry nitrogen | | | | | | |
| Dry nitrogen, | DPR Film | 53.1 | 36.2 | 10.3 | 0 | 29.0 |
| washed in | | | | | | |
| dry nitrogen | | | | | | |

DBD oxidation of grafted DPR coatings yield oxygen rich, SiOₘ coatings.

### EXAMPLE 5

### The APGD Oxidation of Grafted Layers Produced in Examples 1 and 3

Coatings derived from DPR described in the Example 1 and Example 3 above were further oxidised by treatment with atmospheric pressure glow discharge apparatus (1800 sccm total flow rate, 5% oxygen 95% helium, 60 seconds treatment). The oxidised samples were then analysed using XPS and the results are shown in Table 5.

TABLE 5

| Exposure | | | | | | |
|---|---|---|---|---|---|---|
| Environment | Substrate | % C | % O | % Si | % Cl | % SiOₘ |
| Air, washed | DPR Film + | 15.0 | 57.0 | 27.8 | 0.3 | 77.5 |
| in air | APGD | | | | | |
| Dry nitrogen, | DPR Film + | 19.9 | 54.3 | 25.5 | 0.3 | 69.7 |
| washed in | APGD | | | | | |
| dry nitrogen | | | | | | |
| Dry nitrogen, | DPR Film | 28.8 | 49.2 | 22.1 | 0 | 63.6 |
| washed in | | | | | | |
| dry nitrogen | | | | | | |

Hence, APGD oxidation of grafted DPR coatings yield oxygen rich, SiOₘ coatings.

### EXAMPLE 6

### The Preparation of Multilayer Films Derived From Direct Process Residues (DPR) Using DBD

Polyethylene film substrate was prepared by ultrasonic cleaning for 30 seconds in a 1:1 mixture of propan-2-ol and cyclohexane. The polyethylene substrate was then activated using DBD apparatus in air (up to 11 kV, 328 Hz, 2 mm inter-electrode gap, 10 seconds treatment). The polyethylene substrate was sealed in 60 cm³ vessels containing 0.02 ml of DPR with samples elevated on a platform. After exposure to the DPR vapour for 1 hour the samples were removed and washed for one minute in dry toluene. The films derived from DPR on polyethylene substrates were then treated using DBD apparatus in air (up to 11 kV, 328 Hz, 2 mm inter-electrode gap, 60 seconds treatment). Repeating the coating and oxidation procedure 10 times formed multilayers. The oxygen gas barrier performance of the films derived from DPR was then evaluated. Gas transport through the coated films was measured by mass spectrometry, and the barrier improvement factor calculated as [coated substrate gas permeation]/[reference sample gas permeation]. The results are shown in Table 6.

TABLE 6

| | Barrier Improvement |
|---|---|
| Sample | Factor |
| Polyethylene | 1.0 |
| Polyethylene + DPR | 0.5 |
| Polyethylene + DPR + DBD | 0.9 |
| Polyethylene + 10x(DPR + DBD) | 1.1 |

10 times repeat DBD activation/oxidation and DPR grafting, gives no significant oxygen gas barrier improvement.

### EXAMPLE 7

The Preparation of Multilayer Films Derived From Direct Process Residues (DPR) Using APGD (1 Hour Grafting Time)

A polyethylene film substrate was prepared by ultrasonic cleaning for 30 seconds in a 1:1 mixture of propan-2-ol and cyclohexane. The polyethylene substrate was then activated using DBD apparatus in air (up to 11 kV, 328 Hz, 2 mm inter-electrode gap, 10 seconds treatment). The polyethylene substrate was sealed in 60 cm³ vessels containing 0.02 ml of DPR with samples elevated on a platform. After exposure to the DPR vapour for 1 hour the samples were removed and washed for one minute in dry toluene. The films derived from DPR on polyethylene substrates were then treated using APGD apparatus (1800 sccm total flow rate, 5% oxygen 95% helium, 60 seconds treatment). Repeating the coating and oxidation procedure 10 times formed multilayers. The oxygen gas barrier performance of the films derived from DPR was then evaluated. Gas transport through the coated films was measured by mass spectrometry, and the barrier improvement factor calculated as [coated substrate gas permeation]/[reference sample gas permeation]. The results are shown in Table 7.

TABLE 7

| | Barrier Improvement |
|---|---|
| Sample | Factor |
| Polyethylene | 1.0 |
| Polyethylene + DPR + APGD | 1.3 |
| Polyethylene + 10x(DPR + APGD) | 4.1 |

10 times repeat APGD activation/oxidation and DPR grafting (1 hour), yields oxygen gas barrier improvement.

### EXAMPLE 8

### The Preparation of Multilayer Films Derived From Direct Process Residue Using APGD (10 Minutes Grafting Time)

Polyethylene film substrate was prepared by ultrasonic cleaning for 30 seconds in a 1:1 mixture of propan-2-ol and cyclohexane. The polyethylene substrate was then activated using DBD apparatus in air (up to 11 kV, 328 Hz, 2 mm inter-electrode gap, 10 seconds treatment). The polyethylene substrate was sealed in 60 cm³ vessels containing 0.02 ml of DPR with samples elevated on a platform. After exposure to the DPR vapour for 10 minutes the samples were removed and washed for one minute in dry toluene. The films derived from DPR on polyethylene substrates were then treated using APGD apparatus (1800 sccm total flow rate, 5% oxygen 95% helium, 60 seconds treatment). Repeating the coating and oxidation procedure 10 times formed multilayers. The oxygen gas barrier performance of the films derived from DPR was then evaluated. Gas transport through the coated films was measured by mass spectrometry, and the barrier improvement factor calculated as [coated substrate gas permeation]/[reference sample gas permeation]. The results are shown in Table 8.

TABLE 8

| | Barrier Improvement |
|---|---|
| Sample | Factor |
| Polyethylene | 1.0 |
| Polyethylene + 10x(DPR + APGD) | 2.9 |

10 times repeat APGD activation/oxidation and DPR grafting (10 minutes), yields oxygen gas barrier improvement.

### EXAMPLE 9

### Oxidation of Films Derived From Chlorine Terminated PDMS Using DBD

Polyethylene film substrate was prepared by ultrasonic cleaning for 30 seconds in a 1:1 mixture of propan-2-ol and cyclohexane. The polyethylene substrate was then activated using DBD apparatus in air (up to 11 kV, 328 Hz, 2 mm inter-electrode gap, 10 seconds treatment).

Polystyrene substrates were prepared by ultrasonic cleaning for 30 seconds in propan-2-ol. Polystyrene samples were then treated using DBD apparatus in air (up to 11 kV, 328 Hz, 2 mm inter-electrode gap, 10 seconds treatment). The polystyrene substrate was then coated with chlorine terminated PDMS polymer (with typical degree of polymerisation 6-8) from a dropping pipette and left for 40 minutes. The coated polystyrene substrate was then washed for two minutes in heptane. The films derived from chlorine terminated PDMS on polystyrene substrates were then treated using DBD apparatus in air (up to 11 kV, 328 Hz, 2 mm inter-electrode gap, 10 seconds treatment). The coating, washing and oxidation procedure was repeated to form thicker layers. The oxidised samples were then analysed using XPS. The results are shown in Table 9.

TABLE 9

| Exposure Environment | % C | % O | % Si |
|---|---|---|---|
| Polystyrene + PDMS-Cl + wash | 93.9 | 6.1 | 0 |
| Polystyrene + DBD + PDMS-Cl + wash | 63.2 | 23.2 | 13.7 |
| Polystyrene + 2x(DBD + PDMS-Cl + wash) | 60.1 | 24.6 | 15.4 |
| Polystyrene + 3x(DBD + PDMS-Cl + wash) | 49.3 | 25.2 | 25.6 |
| Polystyrene + 4x(DBD + PDMS-Cl + wash) | 44.8 | 33.2 | 22.1 |
| Polystyrene + 5x(DBD + PDMS-Cl + wash) | 39.0 | 33.3 | 27.8 |
| Polystyrene + 6x(DBD + PDMS-Cl + wash) | 45.6 | 28.9 | 25.5 |
| Polystyrene + 7x(DBD + PDMS-Cl + wash) | 40.5 | 30.4 | 29.1 |
| Polystyrene + 8x(DBD + PDMS-Cl + wash) | 45.4 | 31.2 | 23.5 |

Repeated coating, washing and oxidation of chlorine terminated PDMS polymer yields a siloxane coating. Repeated treatments yield multi-layered, thick siloxane films.

1. Method of coating a surface of a low surface energy substrate by the following steps:
(i) exposing the substrate to a silicon containing compound in liquid or gaseous form said silicon containing composition being selected from one or more of a chlorine terminated polydimethylsiloxane, direct process residue, ZₓSiR⁵₄₋ₓ, SiₙY₂ₙ₊₂ or a mixture thereof, where each Z is chloro or an alkoxy group and each R⁵ is an alkyl group or a substituted alkyl group, x is 1,2,3 or 4, n is from 2 to 10 and each Y may be selected from a chloro, fluoro, alkoxy or alkyl group but at least two Y groups must be chloro or alkoxy groups or a mixture thereof to form a grafted coating layer on the substrate surface; and
(ii) post-treating the grafted coating layer prepared in step (i) by oxidation or, reduction.

2. A method in accordance with claim 1 wherein the silicon containing compound is direct process residue.

3. A method in accordance with any preceding claim wherein the grafted coating layer is subsequently oxidised or reduced by applying a plasma or corona treatment.

4. A method in accordance with claim 3 wherein subsequent to oxidation the grafted coating layer may be subjected to any one of the following:
i. further chemical grafting processes to produce an additional mono-layer or multilayer systems,
ii. coated with a plasma polymerised coating
iii. coated with a liquid by means of a traditional coating process, or
iv. laminated to another similarly prepared substrate.

5. A method in accordance with claim 3 or 4 wherein additional grafted coating layers may be applied onto the oxidised coating layer of claim 3 or 4 by applying a further grafted coating layer in accordance with the method of claim 1 and oxidising the resulting layer by applying a plasma or corona treatment.

6. A method in accordance with claim 5 wherein said further grafted coating layer comprises an oxidisable silicon containing compound selected from a chlorine terminated polydimethylsiloxane, direct process residue, ZₓSi R⁵₄₋ₓ, SiₙY₂ₙ₊₂ or a mixture thereof.

7. A method in accordance with claim 6 wherein a top-coat comprising a silicon containing compound is applied to the outermost oxidised grafted coating layer.

8. A method in accordance with claim 3 or 4 wherein the plasma or corona treatment is either dielectric barrier discharge or atmospheric pressure glow discharge.

9. A method in accordance with any preceding claim wherein prior to exposing the low surface energy substrate to a chlorine terminated polydimethylsiloxane, or a silane of the formula, ZₓSiR⁵₄₋ₓ, separately or in combination with each other, the low energy substrate is subjected to a plasma pre-treatment.

10. A method in accordance with any preceding claim wherein prior to exposing the low surface energy substrate to an oxidisable silicon containing compound comprising a direct process residue, or a compound of the formula SiₙY₂ₙ₊₂ said compound may be subjected to a plasma pre-treatment.

11. A method in accordance with either claim 9 or 10 wherein the plasma pre-treatment is by means of atmospheric pressure glow discharge or dielectric barrier discharge.

12. A method in accordance with any preceding claim wherein the substrate is a polyolefin or a polyester.

13. A method in accordance with any one of claims 1 to 10 wherein the substrate comprises a blend of an organic polymeric material and an organosilicon-containing additive which is substantially non-miscible with the organic polymeric material.

14. A method in accordance with any preceding claim wherein the substrate is a film, a natural fibre, a synthetic fibre, a woven fabric, a non-woven fabric, or a powder.

15. A coated substrate obtainable in accordance with any preceding claim.

16. Use of a coated substrate prepared in accordance with any one of claims 1 to 14 as a lamination adhesive, an oxygen and/or moisture barrier, a fuel or soil resistant coating, a hydrophilic or wettable coating, a release coating.
